(19) United States
(12) Patent Application Publication
(10) Pub. No.: US 2009/0169693 A1
(43) Pub. Date: Jul. 2, 2009

(54) Interior-mountable pressure relief valve

(76) Inventor: Karl K. Hoffman, Arlington Heights, IL (US)

Correspondence Address: Niro Scavone Haller & Niro, Suite 4600, 181 W. Madison St., Chicago, IL, 60602, US

(21) Appl. No.: 12/005,596

(22) Filed: Dec. 27, 2007

(51) Int. Cl. B65D 90/34; B65D 33/01; F16K 15/14

(52) U.S. Cl. 426/395; 383/103; 220/89.1; 137/859

(57) ABSTRACT

An interior-mountable pressure relief valve for packages containing food products such as coffee that normally tend to out-gas. The relief valve of the present invention can be made by thermoforming a pocket of a barrier type of semi-rigid film that has a heat seal membrane on one side. An indent can be made in the bottom of this pocket to receive a filter medium that covers an aperture in the bottom of the pocket. The filter medium can be heat-staked to the pocket. A pressure relief valve known in the art containing a base layer, a pair of rails and a flexible membrane can be placed in the pocket. This valve and pocket assembly can be can be treated with a mesh membrane that is heat sealable to the seal side to prevent disassembly or contamination. The product can then be wound on a level wound spool for shipping to an end user. The end user can take the carrier tape and dispense it into a single piece dose and then heat seal the carrier to the inside wall of the package.

### BACKGROUND

1. Field of the Invention

The present invention relates generally to pressure relief valves mountable to product packaging so as to vent pressurized gasses and more particularly to a pressure relief valve that can be mounted on the interior of the package.

2. Description of the Prior Art

Various products that are packages, especially food products, have a tendency to produce gases that can cause a pressure buildup inside the package. Coffee is an example of such a product; however, there are numerous other types of products and packages that have this problem.

Prior art methods use a valve mounted on the exterior of the package that contains a flexible film that in a closed position covers a small aperture. As pressure builds up inside the package, this film opens allowing the excess gas to escape. The film then immediately closes preventing protecting the product from the environment. In particular, the valve prevents outside air from entering the package. An example of this type of valve is taught bye Engle et al. in U.S. Pat. No. 7,178,555. U.S. Pat. No. 7,178,555 is hereby incorporated by reference. Several other valves are known in the art. In my prior applications, I teach a reversed pressure relief valve (application Ser. No. 11/088,678 publishes as 2006/0227462), and a pressure relief valve with stiff support (application Ser. No. 11/133,914 published as 2006/0263497). Application Ser. Nos. 11/1088,678 and 11/133,914 are hereby incorporated by reference.

Prior art valves have all been mounted on the outside of packaging. This has the disadvantage of causing the valve to protrude slightly beyond the package boundary. This is undesirable in many applications. It would be advantageous to have a package pressure relief valve that could be mounted on the interior of the package such that no protrusion appeared on the outside package surface.

### SUMMARY OF THE INVENTION

The present invention relates to an interior-mountable pressure relief valve for packages containing food products such as coffee that normally tend to out-gas. The relief valve of the present invention can be made by thermoforming a pocket of a barrier type of semi-rigid film that has a heat seal membrane on one side. An indent can be made in the bottom of this pocket to receive a filter medium that covers an aperture in the bottom of the pocket. The filter medium can be heat-staked to the pocket. A pressure relief valve known in the art containing a base layer, a pair of rails and a flexible membrane can be placed in the pocket. This valve and pocket assembly can be can be treated with a mesh membrane that is heat sealable to the seal side to prevent disassembly or contamination. The product can then be wound on a level wound spool for shipping to an end user. The end user can take the carrier tape and dispense it into a single piece dose and then heat seal the carrier to the inside wall of the package.

### DESCRIPTION OF THE FIGURES

Attention is directed toward several figures of embodiments of the present invention:

FIG. 1 shows an exploded view of an embodiment of the valve of the present invention mounted in a package.

FIG. 2 shows a perspective section view of the embodiment of FIG. 1 looking down from the top.

FIG. 3 shows a side-view section of an embodiment of the invention.

FIG. 4 shows a top-down perspective view of the assembled valve device.

FIG. 5 shows the valve of the present invention mounted on a package.

FIG. 6 shows how the pressure relief valve of the present invention may be supplied on a roll.

Several illustrations and drawings have been presented to aid in understanding the present invention. The scope of the present invention is not limited to the figures.

### DESCRIPTION OF THE INVENTION

The present invention relates to an interior-mountable pressure relief valve for packaged products such as coffee. In many applications, an exterior-mounted valve is undesirable for various reasons including the protrusion it produces on the outside of the package. The present invention places the valve on the inside of a package carrier that can include a filter medium. This carrier can be processed and the delivered to a packaging company that takes it from a carrier tape and dispenses it as a single piece dose. The carrier can then be heat sealed to the inside wall of the packaging material. The interior-mounted valve of the present invention can be a pre-oiled assembly with a valve in a pocket containing the filter medium and can be delivered and dispensed in a single button style using a simple cut off, pick and place and heat staking methods.

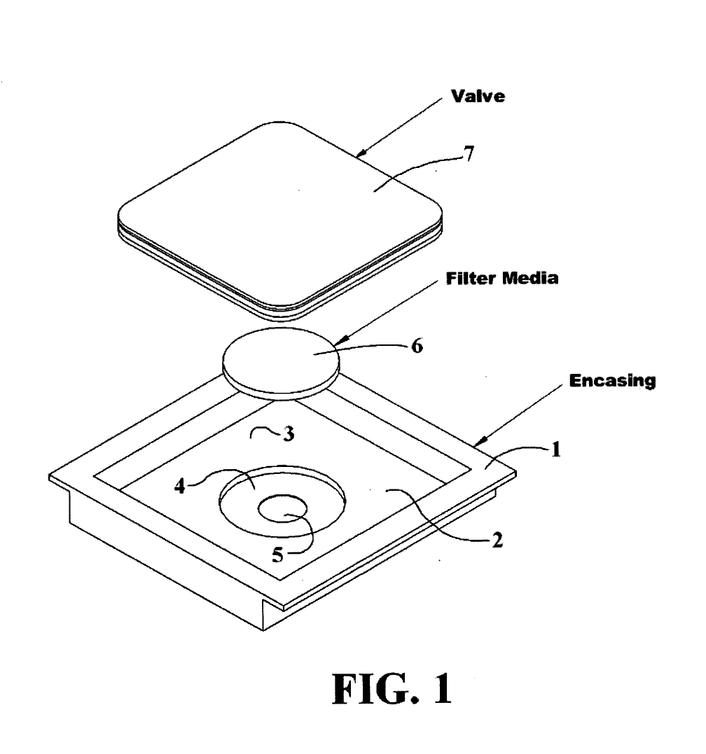

Turning to FIG. 1, an exploded perspective view of an embodiment of the valve device 1 of the present invention can be seen. A pocket 2 can be formed from a barrier type encasing of semi-rigid film by thermoforming. The semi-rigid film can have a heat seal membrane 3 on one side. An indentation 4 can be formed in the bottom of the pocket 3 to form a small recess that can contain a filter medium 6 and a hole 5. The filter medium 6 can be heat staked to the sealant layer 3. A standard valve assembly 7 such as a model PV-28 or PV-41 manufactured by Plitek, LLC of Des Plaines Ill., or similar structure, can then be placed over the filter medium 6. The assembled valve can be pre-assembled and include appropriate food-grade oil. The valve and pocket assembly can be treated with a mesh membrane that is heat sealable to the seal side to prevent any concerns of disassembly or contamination. The product can be placed on a tape and wound on a level wound spool for shipping and dispensing.

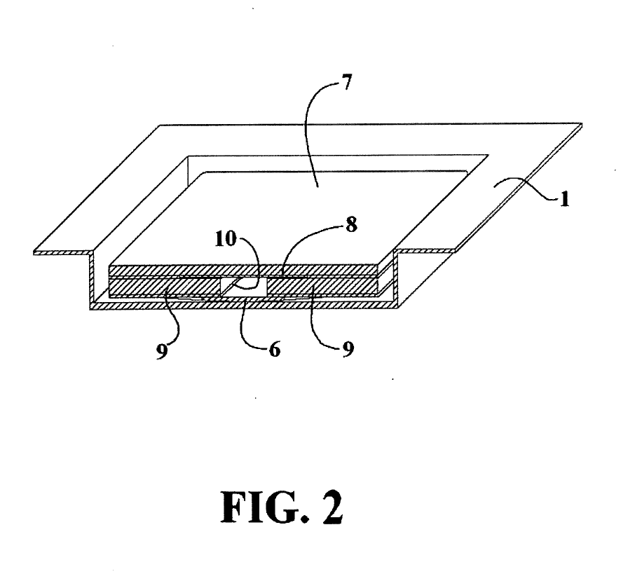

FIG. 2 shows an perspective section view of the embodiment of a valve of the present invention. The valve assembly 7 can be made up of a base 11 that holds a set of rails 9 mounted by an adhesive layer 10. The valve film or membrane 8 can be mounted above the rails 9. As is known in the art, the rails 9 can be from about 1 to about 10 millimeters thick with a preferred thickness being around 4-6 millimeters. The rails 9 form a passageway to the outside when the membrane 8 opens under pressure by being pushed upward. This passageway allows the gas to vent. The membrane 8 normally closes the passageway formed by the rails 9 preventing entry of air or contaminants from the outside. As is known in the art, the film membrane 8 and the base 11 can be made from polyethylene terephthalate manufactured by DuPont Corporation or similar material.

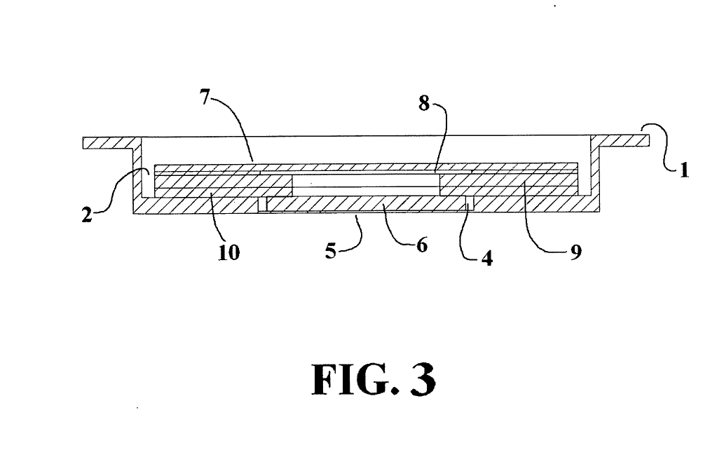

FIG. 3 shows a side section of an embodiment of the present invention. The valve 7 is seated in the pocket 2 formed in the valve device 1. The filter medium 2 covers fits into the indentation 4 and covers a bottom hole 5. The details of the valve 7 that can be seen are the rails 9, adhesive layer 10, and membrane 8. The valve device 1 functions by allowing gas to flow through the filter medium 6, up between the rails 9 and out by displacing the membrane 8. The membrane acts as a one-way valve by closing whenever air or gas tries to flow into the device from the outside. As stated, the entire device 1 can be dispensed from a roll and heat sealed onto a package in an automatic operation.

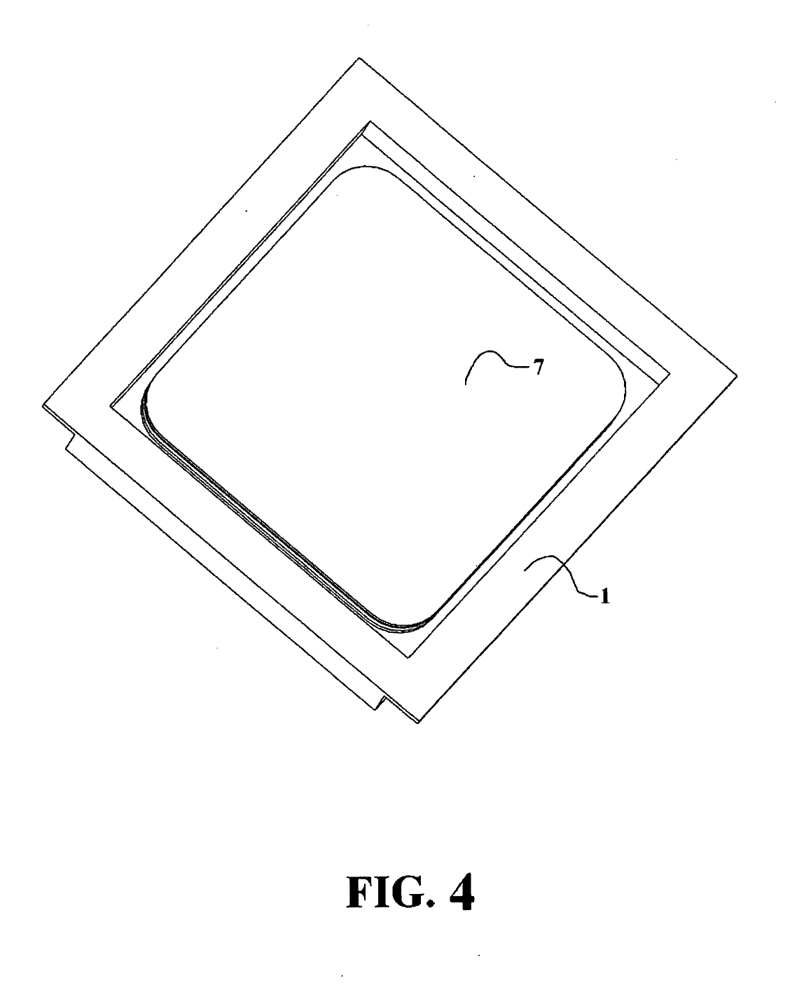

FIG. 4 shows a top-down perspective view of an embodiment of the present invention. The valve 7 can be seen mounted in the valve device 1.

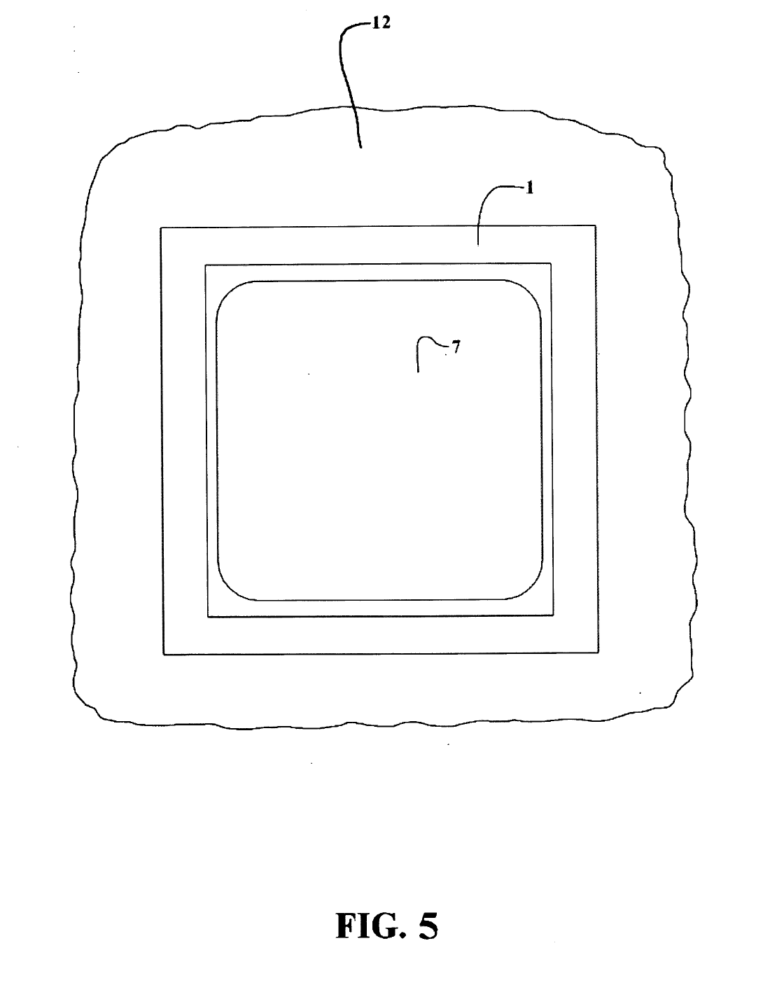

FIG. 5 shows an embodiment of the valve device 1 of the present invention mounted on the interior surface of the package 12. Mounted this way, no protrusion occurs on the outer surface of the package, and the only evidence of the valve is a small aperture in the package.

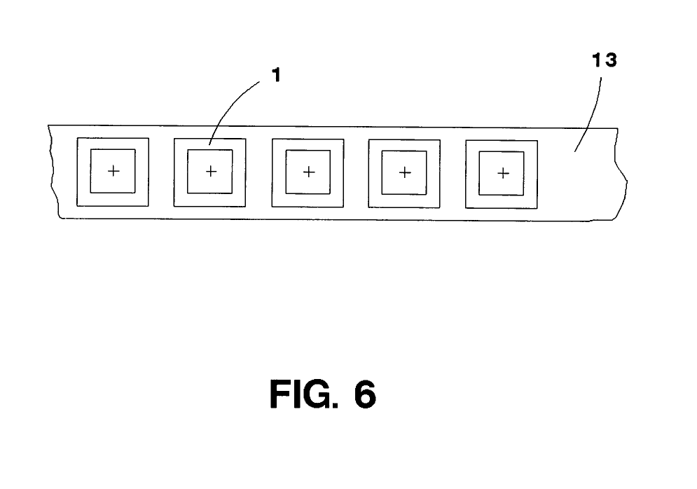

FIG. 6 shows how the assemblies of the present invention can be dispensed from a tape on a reel as is known in the art.

Several descriptions and illustrations have been presented to aid in understanding the present invention. One skilled in the art will realize that numerous changes and variations are possible without departing from the spirit of the invention. Each of these changes and variations is within the scope of the present invention.

I claim:

1. An interior-mounted pressure relief valve assembly comprising:
a carrier structure including a pocket with a recessed bottom;
an aperture in said recessed bottom;
a filter medium in said recessed bottom covering said aperture;
a pressure relief valve in said pocket mounted above said filter medium.

2. The interior-mounted pressure relief valve assembly of claim 1 wherein said pressure relief valve comprises:
a base layer;
an aperture in said base layer communicating with said aperture in said recessed bottom;
a pair of rails mounted on said base layer, wherein said rails form a passageway for venting gases;
a flexible membrane attached to said rails wherein, said flexible membrane normally closes said passageway, and wherein said flexible membrane opens under pressure to vent gasses into said passageway.

3. The interior-mounted pressure relief valve assembly of claim 1 wherein said carrier structure is a barrier type semi-rigid film with a heat seal membrane on one side.

4. The interior-mounted pressure relief valve assembly of claim 1 wherein said filter medium is heat-staked to said recessed bottom.

5. The interior-mounted pressure relief valve assembly of claim 2 wherein said flexible membrane is polyethylene terephthalate.

6. The interior-mounted pressure relief valve assembly of claim 2 wherein said base layer is polyethylene terephthalate.

7. The interior-mounted pressure relief valve assembly of claim 2 wherein said rails are attached to said base layer with an adhesive layer.

8. The interior-mounted pressure relief valve assembly of claim 1 wherein said pressure relief valve contains a food-grade oil.

9. An interior-mounted pressure relief valve assembly comprising:
a carrier structure including a pocket with a recessed bottom;
an aperture in said recessed bottom;
a filter medium in said recessed bottom covering said aperture;
a base layer mounted in said pocket above said filter medium;
an aperture in said base layer communicating with said aperture in said recessed bottom;
a pair of rails mounted on said base layer, wherein said rails form a passageway for venting gases;
a flexible membrane attached to said rails wherein, said flexible membrane normally closes said passageway, and wherein said flexible membrane opens under pressure to vent gasses into said passageway, wherein said base layer, said rails and said flexible membrane from a gas-venting valve.

10. The interior-mounted pressure relief valve assembly of claim 9 wherein said carrier structure is a barrier type semi-rigid film with a heat seal membrane on one side.

11. The interior-mounted pressure relief valve assembly of claim 9 wherein said flexible membrane is polyethylene terephthalate.

12. The interior-mounted pressure relief valve assembly of claim 9 wherein said base layer is polyethylene terephthalate.

13. The interior-mounted pressure relief valve assembly of claim 9 wherein said rails are attached to said base layer with an adhesive layer.

14. The interior-mounted pressure relief valve assembly of claim 9 wherein said gas venting valve contains food-grade oil.

15. A method for making an interior-mountable pressure relief valve assembly comprising the steps of:
thermoforming a pocket in a barrier type semi-rigid film of the type having a heat seal membrane on one side;
indenting the bottom of said pocket to form a shallow recess;
heat staking a filter medium into said shallow recess;
placing an assembled pressure relief valve into said pocket;
treating said assembled pressure relief valve and said pocket with a heat sealable mesh membrane.

16. The method for making an interior-mountable pressure relief valve assembly of claim 15 further comprising winding a plurality of interior-mountable pressure relief valves on a spool for shipping to an end customer.

17. The method for making an interior-mountable pressure relief valve assembly of claim 15 wherein said pressure relief valve is treated with food-grade oil.

18. The method for making an interior-mountable pressure relief valve assembly of claim 15 wherein said pressure relief valve comprises:
a base layer;
an aperture in said base layer communicating with an aperture in said shallow recess;
a pair of rails mounted on said base layer, wherein said rails form a passageway for venting gases;
a flexible membrane attached to said rails wherein, said flexible membrane normally closes said passageway, and wherein said flexible membrane opens under pressure to vent gasses into said passageway.

19. The method for making an interior-mountable pressure relief valve assembly of claim 18 wherein said flexible membrane is polyethylene terephthalate.

20. The method for making an interior-mountable pressure relief valve assembly of claim 18 wherein said base layer is polyethylene terephthalate.
